(19) United States
(12) Patent Application Publication
(10) Pub. No.: US 2006/0260172 A1
(43) Pub. Date: Nov. 23, 2006

(54) Apparatus for retrieving a fish attached to a line and method for retrieving such fish

(76) Inventor: Warren E. Hufe JR., Southhold, NY (US)

Correspondence Address: ABELMAN, FRAYNE & SCHWAB, 666 THIRD AVENUE, 10TH FLOOR, NEW YORK, NY, 10017, US

(21) Appl. No.: 11/433,542

(22) Filed: May 12, 2006

Related U.S. Application Data
(60) Provisional application No. 60/682,221, filed on May 17, 2005.
(60) Provisional application No. 60/742,187, filed on Dec. 2, 2005.

(51) Int. Cl. A01K 77/00; A01K 97/00

(52) U.S. Cl. 43/5; 43/4

(57) ABSTRACT

A device and method for retrieving a fish or other animal or object attached to a line includes a tube having a flexible wall extending between a distal end portion and a proximal end portion. The tube wall defines a tube aperture aligned with a central longitudinal axis, and includes a first longitudinal edge and a second opposed longitudinal edge, where at least one of the longitudinal edges is flexibly movable relative to the opposed longitudinal edge. The first and second longitudinal edges selectively define a tube passageway for receiving the line. A funnel having a flexible wall defining a funnel aperture is connected to the distal end portion of the tube, wherein the funnel aperture is aligned with the tube aperture along the central longitudinal axis. A plurality of fish retention members is positioned in the tube aperture and accommodates unidirectional passage of the fish through the tube for retrieval thereof. In an alternative preferred embodiment a tubular member includes a plurality of inwardly biased fish retention members formed monolithically therewith, and a flared distal end portion which is monolithic with the tubular member. One, two or more rows of such retention members may be provided. While four (4) fish retention members are preferred in each row, any number may be provided. Preferably two rows of four (4) retention members are provided.

### CROSS-REFERENCE TO RELATED APPLICATIONS

This application claims priority to provisional application Nos. 60/682,221, filed May 17, 2005 and 60/742,187, filed Dec. 2, 2005, the disclosures of which are incorporated herein and made a part of this application.

### BACKGROUND OF THE INVENTION

1. Field of the Invention

The present invention relates to devices and methods for retrieving objects tethered to a line, and more specifically to an apparatus and method for retrieving fish attached to a line.

2. Description of the Related Art

Once an angler hooks a fish and successfully brings the fish into proximity, the angler has to retrieve, retain and then extricate the hook from the fish. This can be a challenging task under circumstance, such as in the confines of a small boat or along a rocky shore. Traditional fish retrieving nets can remove the fish from the water, but still require manually dealing with a fish that is wriggling, slippery and may have stingers or sharp spines.

Anglers need a way to securely retrieve the fish from the water and safely retain the fish while removing the hook. Under many circumstances, the angler also desires to measure the fish or to determine whether the catch is within legal limits. This can require the angler to suspend the fish from the hook or hold the catch and simultaneously measure the fish. This process is particularly important because many anglers fish for sport and without the intention of keeping their catch, but they desire to measure their catch and safely remove the hook with as little injury to the angler or the fish as possible.

### SUMMARY OF THE INVENTION

A fish retrieving apparatus is disclosed that can be advantageously used by anglers for retrieving fish caught on a line. In particular, I have invented an apparatus and method for retrieving a fish that can readily receive the fish while connected to the fishing line, as well as retain and contain the fish while the angler removes the hook. My device and method also enables measuring the length of the catch while it is retained in the receiving device.

Broadly stated, the invention relates to an apparatus for retrieving fish attached to a line, which comprises a generally tubular member defining a tubular aperture for reception of the fish therein, the wall of the tubular member including a generally longitudinally extending opening for passage of the line, and at least one fish retention member associated with the generally tubular member and extending inwardly sufficient to engage a fish guided into the tubular aperture by the line. Preferably, the apparatus includes a plurality of such fish retention members.

The apparatus of the present invention includes a tube having a flexible wall extending between a distal end portion and a proximal end portion, where the tube wall defines a tube aperture aligned with a central longitudinal axis. The tube wall further includes a first longitudinal edge and a second opposed longitudinal edge, where at least one of the longitudinal edges is flexibly movable relative to the opposed longitudinal edge. Additionally, the first longitudinal edge and second opposed longitudinal edge of the tube define a tube passageway for slidably receiving the line.

A funnel having a flexible wall extends between a distal end portion and a proximal end portion of the funnel, such that the wall defines a funnel aperture therebetween. The funnel is connected to the distal end portion of the tube, such that the funnel aperture is aligned with the tube aperture along the central longitudinal axis. In one embodiment, the funnel includes opposing longitudinal edges formed between distal and proximal end portions of the funnel. The opposing longitudinal edges of the funnel form a funnel channel or passageway for receiving the line attached to the object to be retrieved.

At least one retention member is positioned in the tube aperture to accommodate unidirectional passage of an object through the aperture of the tube. In one embodiment, the at least one retention member includes a plurality of retention members that circumscribe an inner surface of the tube wall proximate the distal end portion of the tube. The at least one retention member has a first end coupled to the inner surface of the tube wall, and a second end that extends angularly towards the central longitudinal axis and the proximal end portion of the tube, thereby defining a first biased position. The retention member is flexible, and in response to an external force from the object (e.g., fish) entering the tube aperture, the retention member moves to a second position proximate the inner surface of the tube wall. Once the object passes by the retention member and the external force from the object is reduced or alleviated, the retention member moves back to the first position. The retention member, in its first position, prevents the object from exiting through the distal end of the tube and/or funnel.

In operation, an object, such as a fish, is illustratively hooked and reeled in by an angler. Once the fish is in proximity of the angler, the angler places the object retrieving device over the line, such that the line is positioned in the funnel passageway. The angler pulls on the line such that the line slides along the funnel passageway and into the adjacent tube passageway, as the fish is drawn into the distal end of the funnel. As the angler continues to draw in more line, the line slips into the tube aperture and the fish enters the distal end of the funnel. Further pulling on the line pulls the fish into the tube aperture, such that the retention members are forced back by the fish towards the inner surface of the tube wall and the proximal end portion of the tube.

Once at least a portion of the fish passes the retention members, they return to their normal biased inwardly position, thereby preventing the fish from sliding or escaping out the distal end portion of the fish retrieving device. The angler can use the tube portion of the device to securely retain the fish to illustratively unhook and/or measure the fish in a manner safe to both the angler and the fish. The fish is removed from the device by sliding the fish out through the proximal end portion of the tube.

In an alternative embodiment the tube includes two rows of fish retention members formed monolithically about the periphery and the distal end of the tube is flared to guide the fish into the tube. In another embodiment one row of such retention members is provided.

The invention also relates to a method for retrieving a fish attached to a line, utilizing a generally tubular member defining a tubular aperture for reception of the fish therein, the wall of the tubular member including a generally longitudinally extending opening for entry and passage of the line, and at least one fish retention member associated with the tubular member, the at least one fish retention member extending inwardly thereof sufficient to engage a fish guided into the tubular aperture by the line, comprising positioning the tubular member adjacent the fish; and guiding the fish adjacent the tubular aperture of the generally tubular member utilizing the line, and guiding the fish into the generally tubular member until the at least one fish retention member engages the fish to retain it within the generally tubular member. The generally tubular member preferably includes a plurality of such fish retention members.

### BRIEF DESCRIPTION OF THE DRAWINGS

Preferred embodiments of the invention are described hereinbelow with reference to the drawings, wherein:

FIG. 1 is a top front and right side perspective view of a device for retrieving fish attached to a line according to the invention;

FIG. 2 is a top front and a partial side view of the device for retrieving fish of FIG. 1 showing the line positioned through the device and the fish being drawn into the device by the line;

FIG. 3 is a cross-sectional view taken along lines 3-3 of FIG. 2 showing a fish hooked on a line, and entering a tube of the device with the line running from the fish through a passageway defined in the tube;

FIG. 4 is a top front and side perspective view of the device of FIG. 1, with the head of the fish extending at least partially from a proximal end of the tube;

FIG. 5 is a front elevational view partially in cross-section of the device taken along lines 5-5 of FIG. 4, and showing a fish positioned in the tube and a hand of the angler gripping the tube to fix the position of the fish therein;

FIG. 6 is a top side and front perspective view of the device for retrieving fish of FIG. 1, while releasing the fish into a pail;

FIG. 7 is a cross-sectional view of the device taken along lines 7-7 of FIG. 1 depicting the first embodiment of the device having a plurality of retention members attached to the tube by fasteners; and

FIG. 8 is a cross-sectional view of the device depicting a second embodiment of the device, wherein a plurality of retention members are monolithically formed with the tube;

FIG. 9 is a left side elevational view of an alternative embodiment of the invention, incorporating two sets of retention members in the tube;

FIG. 10 is a cross-sectional view taken along line 10-10 of FIG. 9;

FIG. 11 is a cross-sectional view taken along line 11-11 of FIG. 9;

FIG. 12 is a left side elevational view of still another alternative embodiment of the invention, incorporating a single set of retention members in the tube.

Unless stated otherwise, the drawings shown and discussed in the FIGS. are not drawn to scale, but are shown for illustrative purposes only.

### DETAILED DESCRIPTION OF THE PREFERED EMBODIMENTS

FIG. 1 shows an embodiment of a device 10 for retrieving a fish 2 that has been caught by a fishing hook or lure 3 attached to a fishing line 4. Fish retrieving device or device 10 includes a tube 20 and a funnel 40 that are aligned along a central longitudinal axis-X, and a handle 70.

Tube 20 includes a distal end portion 22 that has a distal edge 23, and a proximal end portion 24 that has a proximal edge 25. Tube 20 comprises a flexible tubular wall 30 having a first longitudinal end portion 32 that includes a first longitudinal edge 33, and an opposed second longitudinal end portion 34 that includes a second longitudinal edge 35. The tube wall 30 extends between the distal edge 23 and proximal edge 25 and defines an aperture 26 aligned with the central longitudinal axis. Tube 20 and funnel 40 define cross-sectional areas normal to the longitudinal axis. The tube 20 is fabricated from a flexible material (e.g., plastic, non-corrosive sheet metal, among other materials) to allow for decreases or increases in the cross-sectional area thereof to accommodate fish 2 of different sizes.

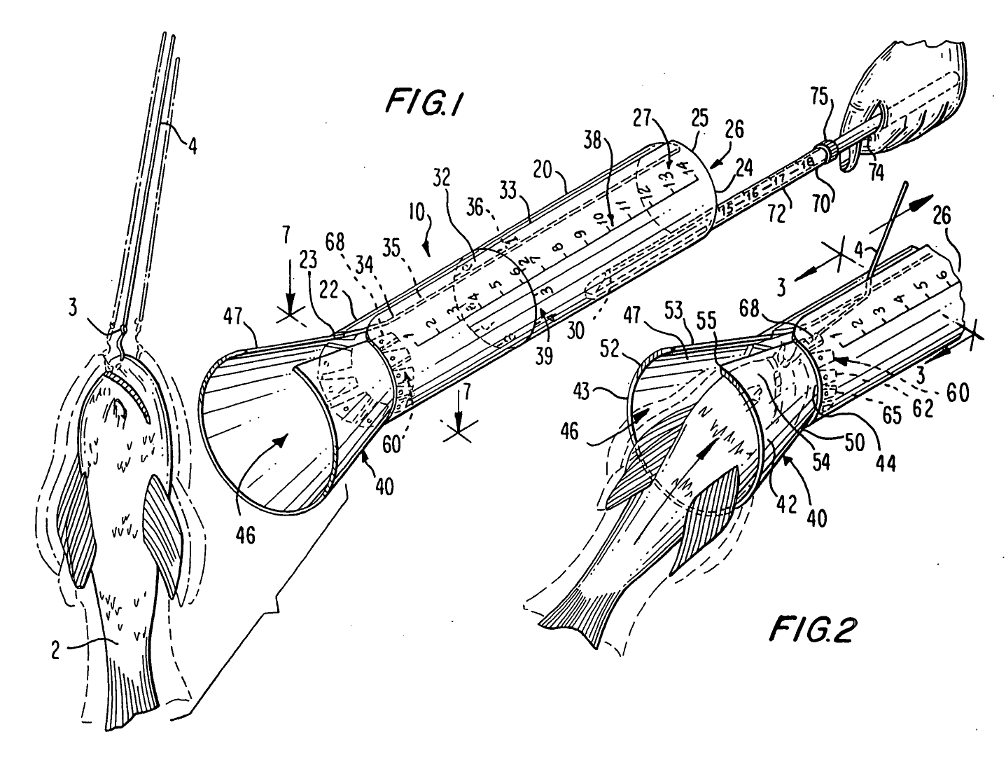

As shown in FIGS. 1 and 2, device 10 is biased to a first position that defines a first cross-sectional area normal to the longitudinal axis. Device 10 can be moved between the first position and a second position by manually compressing and flexing the tube 20, for example, to flex the device 10 about the longitudinal axis, such that there is a decrease in the cross-sectional area normal to the longitudinal axis. Similarly, the flexibility of the tubular device 10 allows for expansion from the first position back to the second position, such that the cross-sectional area normal to the longitudinal axis of tube 20 is increased, particularly when a fish is retrieved.

In one embodiment, longitudinal end portions 32 and 34 are overlapped and can be in direct contact with, or in a spaced relation to, the opposed portion of tubular wall 30 in the first position. A passageway or gap 27 is defined between longitudinal end portions 32 and 34 when at least one of end portions 32, 34 is in a spaced relation from the opposed portion of wall 30. The passageway 27 is intended for passage of the line 4. Tube passageway 27 is preferably in communication with tube aperture 26, as well as with funnel passageway 47 and funnel aperture 46, as discussed below in further detail with respect to FIGS. 3, 4, and 6.

Alternatively, opposed longitudinal end portions 32 and 34 and/or edges 33 and 35 can be in any positional relationship, such as for example, in alignment, abutting and/or define an axially aligned gap or passageway 27, such that device 10 can flex to increase or decrease the size of the passageway 27. That is, the tube passageway 27 can be said to have a first (normal) position defined by the distal relationship between the longitudinal end portions 32 and 34 and their respective edges 33 and 35 with respect to each other. By flexing the tube wall 30, the size of the tube passageway 27 can be increased or decreased relative to the normal position.

In one embodiment, the fish retrieving device 10 includes a measuring scale 38 to measure the length along the longitudinal axis, as well as a circumferential scale 39 to measure the girth normal to the longitudinal axis. In a preferred embodiment, scales 38 and 39 are positioned on tube 20. Scale 38 can also extend along handle 70 as shown, and/or funnel 40. Scale 39 is preferably positioned as a preset perimeter-measuring tool, such that, for example, the outer overlapped edge 33 of the first longitudinal end portion 32 can be used as an indicator to the measurement of girth. Both scales 38 and 39 can include English and/or metric standards of measurement, as well as indicate the minimum permissible (legal) length/girth for different fish species in one or more jurisdictions. Scales 38 and 39 can be provided by molding, etching, raised characters, labels, among other conventionally known labeling techniques to provide scaling indicators on the device 10.

Referring again to FIGS. 1 and 2, funnel 40 comprises a distal end portion 42, a proximal end portion 44 and a wall 50. Distal end portion 42 includes a distal edge 43, and proximal end portion 44 includes a proximal edge 45. The funnel wall 50 includes an inner surface formed between the distal edge 43 and proximal edge 45 that defines a funnel aperture 46. Funnel aperture 46 is aligned with tube aperture 26 along the longitudinal axis. Distal end portion 42 of the funnel 40 preferably defines a larger cross-sectional area normal to the longitudinal axis than the cross-sectional area normal to the longitudinal axis of proximal end portion 44 and/or tube 20.

Funnel wall 50 includes a first longitudinal edge 53 and an opposed second longitudinal edge 55. Edges 53 and 55 preferably define a tapered passageway 47 that can have rounded corners with edge 43 and form a chute that decreases in circumferential width from the distal end portion 42 to the proximal end portion 44. Funnel passageway 47 is in communication with aperture 46, as well as tube passageway 27 (when defined), and aperture 26 of tube 10. Funnel wall 50 is flexibly connected with tubular wall 30 such that passageway 47 increases or decreases in radial width depending upon the corresponding increase or decrease in cross-sectional area of tubular wall 30 normal to the longitudinal axis.

In another embodiment of the funnel 40, the wall 50 can alternatively include a rounded extension or flared lip on the distal end 22 that defines at least an abbreviated passageway 47 and aperture 46 into passageway 27 and aperture 26. The rounded extension or flared lip can be molded as part of distal end portion 22 of the tube 20. The length of funnel 40 along the longitudinal axis is typically dependent upon a particular desired angling application. Similarly, wall 50 is shown as having a conical shape, but it can also define a scoop shape having an extended lower distal edge 43 to assist in receiving and retrieving a fish 2 from the water. The funnel 40 can further include longitudinal edges 53 and 55 that at least partially overlap, as described above regarding longitudinal edges 33 and 35 of the tube 20.

Referring now to FIGS. 2 and 3, proximal end portion 44 of funnel 40 preferably includes a fastener mechanism 68 and a retention member 60. Fastener mechanism 68 connects funnel 40 to tube 20. Retention member 60 limits the passage in the distal direction and accommodates passage in the proximal direction within apertures 26 and/or 46 from device 10.

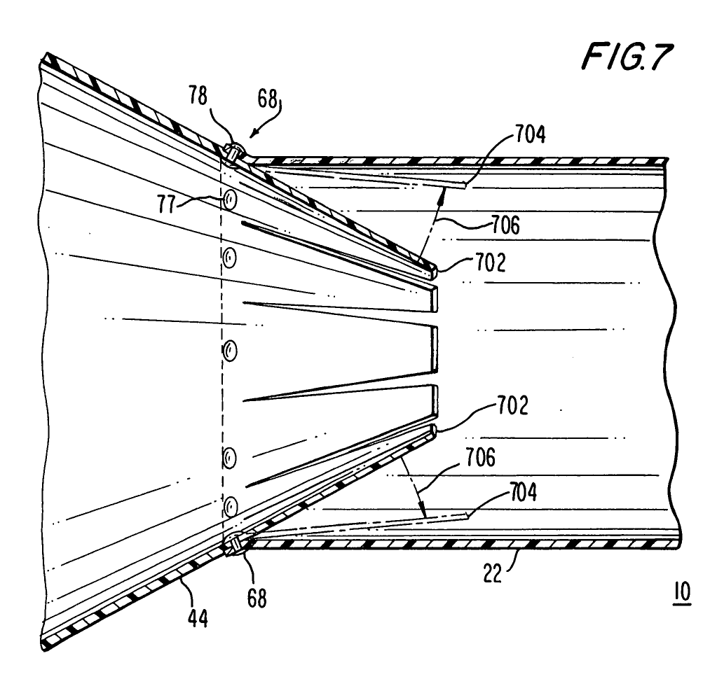

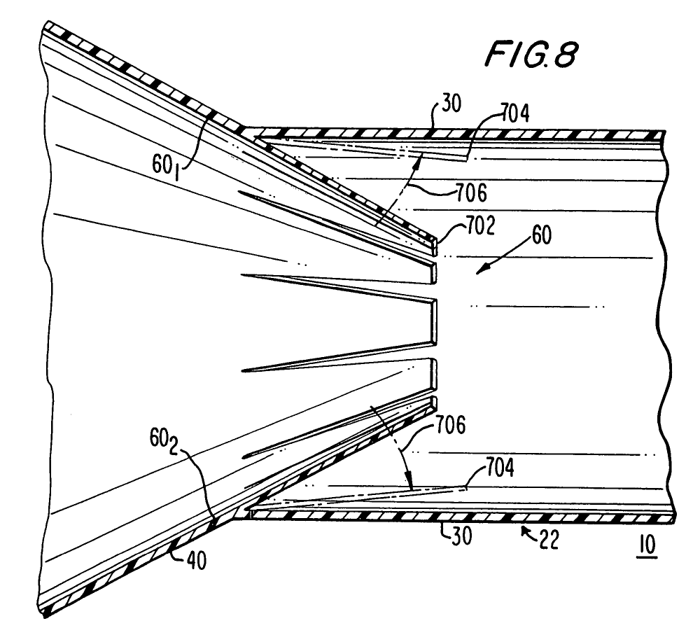

Referring to FIG. 7, proximal end 44 of the funnel 40 and distal end portion 22 of the tube 20 are connected and longitudinally aligned as shown. In one embodiment, funnel 40 and tube 20 are removably attached to each other, illustratively, by a fastener mechanism 68. The fastener mechanism 68 can include, for example, at least one aperture 77 formed through the distal end portion 22 of the tubular wall 30 and the proximal end portion 44 of the funnel wall 50 for receiving a removable fastener 78 to affix the two structural components together. The apertures 77 can have any suitable alignment and size for receiving a fastener 78 that connects the tube and funnel together.

For example, the apertures are respectively aligned and employ structures such as abutting flanges, as well as overlapped arrangements. Alternatively, the fastener mechanism 68 can removably connect proximal end portion 44 and distal end 22 by a screw, snap, clip or other conventionally known removable fasteners. Alternatively, tube 20 and funnel 40 can be fixedly attached to each other. Methods for fixedly connecting funnel 40 and tube 20 include those well known in the industry such as rivets, heat bonding, adhesive, or any other conventionally known techniques.

Fish retention members 60 are coupled proximate the distal end portion 22 and extend a distance at a predetermined angle into the interior of tube 20 towards the proximal end portion 24. The retention members are flexible and angled inwardly towards the center of the tube 20 at a first (normal) position. In one embodiment, retention members 60 are connected to wall 30 by fastening means, as described above with respect to the attachment mechanism 68 illustratively shown in FIG. 7. Alternatively, the retention members 60 can be fixedly connected to the distal end of the tube 20 and/or funnel 40 as a single monolithic assembly as illustratively shown in FIG. 8.

FIG. 8 is a cross-sectional view of an embodiment of the device 10 in which a plurality of retention members 60 is monolithically formed with the tube 20, preferably by a molding process. The plurality of retention members 60, for example, retention members 60, and 602, are shown being monolithic with the tube wall 30. That is, the retention members 60 do not require fasteners for coupling to the wall 30. Rather, the retention members 60 and wall 30 are formed monolithically, illustratively, by injection molding fabrication techniques of polymeric molding material, such as polyvinyl chloride (PVC) or the like.

As shown in FIG. 8, the funnel 40 may also be formed with the tube 30 and retention members 60 as part of the single monolithic assembly. Alternatively, the retention members can be formed monolithically with the proximate end portion 44 of the funnel 40. In this latter embodiment, the proximate end portion 44 of the funnel 40 is coupled to the distal end portion 22 of the tube by fasteners, such that the retention members 60 extend a distance within the aperture 26 of the tube 20.

For any of the embodiments discussed with respect to FIGS. 7 and 8, the length of the retention members 60 are optimized to prevent a fish 2 from backing out of the tube 20 once the fish 2 is drawn therein. That is, the length of the retention member 60 is predetermined to accommodate various types of fish of differing girths or circumferences, as well as varying lengths.

The operation of the apparatus will now be described. When the angler catches a fish 2, the angler draws the fish 2 forward through the funnel 40 and then into the tube 20.

The plurality of retention members 60 circumscribe the interior wall of the tube, and each retention member serve as a cantilevered beam, which in its first normal biased position 702, extend inwardly from wall 30 or 50 at a predetermined angle proximally and toward the longitudinal axis (see FIG. 7). The fish 2 typically exerts outward forces onto the retention members 60, which pushes the retention member 60 from its first normal biased position 702 to a second position 704 (drawn in phantom in FIG. 7) along the central longitudinal axis and towards the interior wall 30 of the tube 20.

Each retention member 60 in the preferred embodiment includes a pivot 64 that is a living or flexible hinge that is biased to the first position 702. When retention members 60 are displaced from the first position by outward forces, each retention member 60 pivots flexibly towards the adjoining tubular wall 30 to the second position 704, which is against the bias of retention member 60. As the displacing forces from the fish 2 reduce or discontinue at particular retention members 60, the inward biasing of the retention members 60 causes it to return to the normal first position 702. Pivot 64 of retention member 60 is constructed to limit response to a distally directed force in aperture 26 when in the first position 702, and thereby preclude fish of a predetermined size from exiting device 10. Thus, the retention members 60 are movable radially outward along paths 706 in response to outward forces applied by the fish.

In one embodiment, upper edges 65 of retention members 60 are radially aligned with the interior wall 30 of the tube 20. The upper edges 65 have a width sized to engage or grip the fish 2 (e.g., along or between the scales of the fish) to prevent the fish 2 from exiting (sliding) out the distal end portions 22 and 42 of the tube 20 and funnel 40, respectively. Once the fish 2 is drawn past or ceases to exert an outward force on the retention member 60, the retention member 60 automatically returns (springs back) to the first position, thereby precluding the fish 2 from exiting (backing out) from the tube 20 and funnel 40.

It is understood that retention members 60 are preferably elongate and can have any shape, such as for example, a flat, arcuate and/or angular shape, as well as having various spacing distances therebetween. Such shapes can also provide additional biasing qualities for each member 60 to further assist in retaining or gripping a fish 2 of a predetermined or selected size and/or weight in position within aperture 26. The length, density, flexibility, shape and presence of retention members 60 can vary along the length of device 10, depending upon the particular application. Similarly, each retention member 60 can be made of a plurality of components that are pivotally or rotatably connected with defined limits of travel and include a separate bias member.

It is further understood that different applications of the device 10 can employ different types and/or arrangements of retention members 60 to preclude and accommodate the distal and proximal passage of different sizes and/or shapes of fish from device 10. For example, FIG. 3 illustrates ten retention members 60, however such number is not considered as being limiting. It is further understood that the use of the term fish attached to a line herein can encompass inanimate objects and/or other animals that are attached or tethered to a line, wire, rope, chain, and/or rod or the like, which restricts the movement of the animal.

As shown in FIGS. 1-3, fish retrieving device 10 in the preferred embodiment can also include a handle 70 that has an adjustable length and extends generally parallel to the longitudinal axis from proximal end portion 24 of tube 20. Handle 70 includes a handgrip positioned on the proximal end 24 and additional handgrips and/or handles 70 can be positioned on device 10. Handle 70 also can be a separate component that is connected to tube 20 by an attachment mechanism, such as that described previously between funnel 40 and tube 20, or molded as a unitary assembly with tube 20 and/or funnel 40, such as for example, an extension of wall 30.

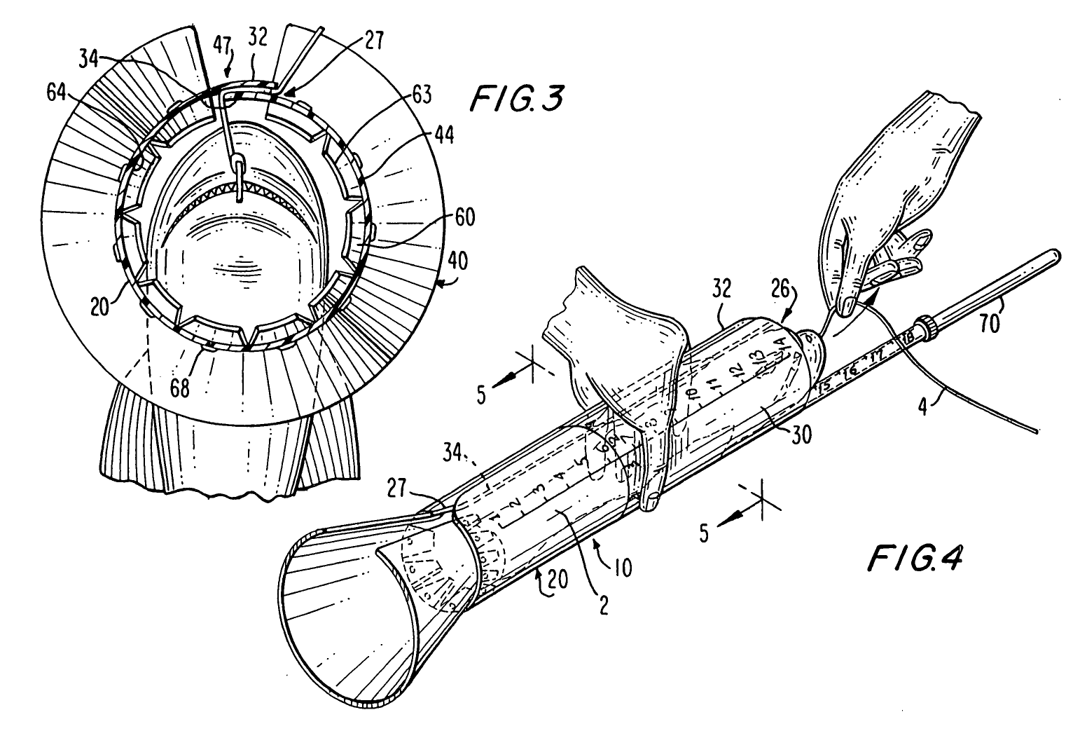

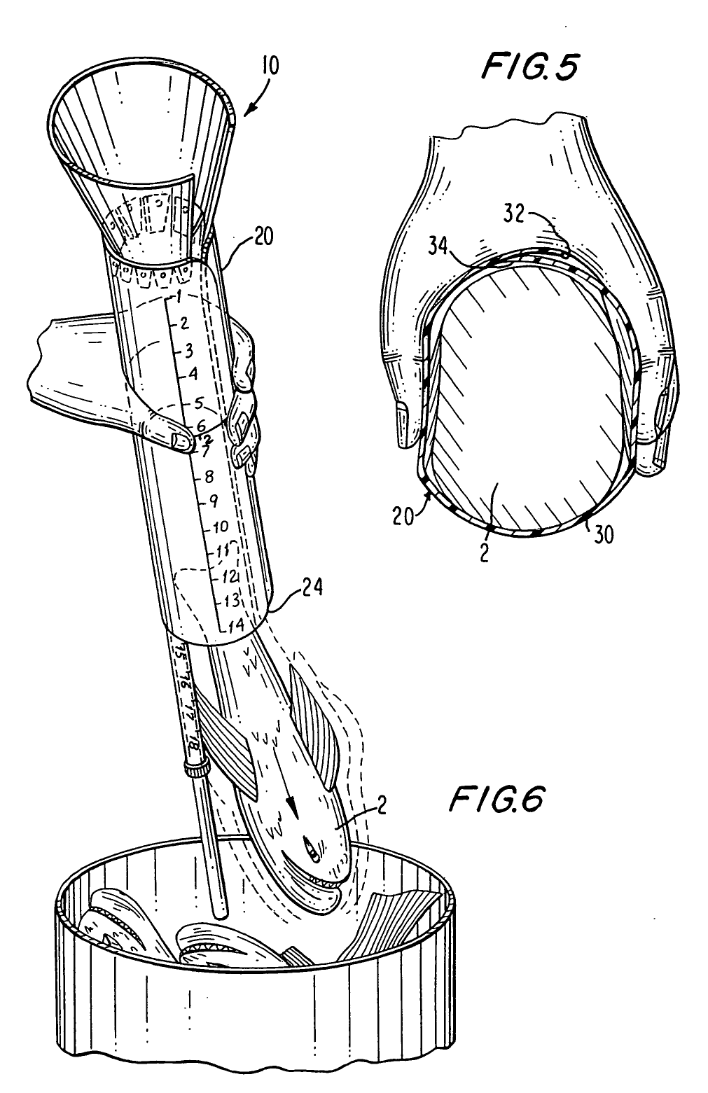

Handle 70 extends the reach of the angler, as required, to receive line 4 and scoop and/or draw fish 2 into device 10. In one embodiment, handle 70 is telescopically adjustable and includes a distal member 72 slidingly engaged with a proximal member 74. A locking mechanism 75 is included to fix handle 70 at a given length. Handle 70 is preferably positioned opposite the position of longitudinal end portions 34 and 36 on tube 20. Handle 70 and/or another portion of retrieving device 10, such as the proximal end portion 24 of tube 20, can include a receptacle or through-hole 76 (FIG. 4) that accommodates the hanging of the retrieving device 10. Depending upon the size of the particular device 10 and the expected weight of fish 2, device 10 can include additional handles 70 and/or handgrips on the wall 30, as required, to assist one or more anglers in retrieving fish 2 retained in device 10 from the water.

Various parameters of the device 10 can vary by design choice, depending on the application of the device 10. Such variable parameters illustratively include the cross-sectional shape of device 10 in the first position, the longitudinal and lateral length of tube 20 and funnel 40, as well as the thickness and material of the walls 30 and 50. These and other parameters of device 10 can also vary the flexibility of at least one or more portions of walls 30 and 50, and thus the dimensional range that can be accommodated between the first and second positions of the tube 20. For example, a cross-section normal to the longitudinal axis of a fish at its maximum area can vary in its shape, length of the perimeter, and size of the area to accommodate relatively flat to circular shaped fish. Thus, it is desirable for device 10 to accommodate retrieving and retaining a wide variety of fish 2. It is understood that the tube 20 and funnel 40 can have cross-sectional shapes that are elliptical and tapering along the longitudinal axis, and can flex to expand or contract to accommodate a range of cross-sectional areas of fish.

Device 10 is preferably made of a polymeric material that is sufficiently flexible and/or bendable to expand and contract axially to accommodate a predetermined range of sizes of fish 2. Tube 20 is preferably made of transparent materials that can assist in the identification of parameters, such as the specie, length, girth and maturity of the retrieved fish 2. Alternatively, wall 30 can at least include transparent portions or be translucent or opaque, as well as have a plurality of holes and/or a honeycomb type structure that enables direct viewing of the retrieved fish. Funnel 40 is also preferably transparent, but because it can scoop and retrieve, the funnel 40 can also be constructed of a material that has increased visibility underwater, and thus be readily positioned for the retrieval of fish 2, illustratively, in a murky water environment at an extended distance. Additionally, device 10 is preferably constructed of a material to float on water.

Two or more different sized devices 10 can be provided collectively to form a kit, such that one or more kits of different retrieving devices 10 can accommodate a range of fish. For example, the kit can include devices 10 having various cross-sectional areas and/or perimeter shapes for fish found in one or more types of water environments or geographic localities.

In operation, as shown in FIG. 1, fish retrieving device 10 is shown with handle 70 in an extended position in proximity to a fish on a line. Fish retrieving device 10 is held by the angler and is positioned to receive line 4 and fish 2 for the retrieval and temporary retention of fish 2. Fish retrieving device 10 can also be partially positioned in the water and/or submerged to receive and retrieve fish 2 directly from the water.

Referring now to FIGS. 2 and 3, once the angler catches a fish, the fish is reeled in near the angler to allow placement of the funnel 40 over the fishing line 4. In particular, the funnel 40 is placed around (e.g., over) the line 4, such that a portion of fishing line 4 proximate the fish 2 is initially positioned through narrowing passageway 47 and/or aperture 46, and slidably enters into passageway 27 and aperture 26 of the tube 20. Fish 2 is drawn into aperture 46 of funnel 40 and aperture 26 of tube 20 by drawing or pulling on line 4 positioned at least partially through passageway 27.

The positioning of fishing line 4 through passageways 47 and 27 can separate longitudinal edges 33 and 35 from wall 30 of tube 20 to form passageway 27, as required. Walls 30 and 50 can flex, as required, to accommodate fish 2. Retention members 60 are displaced to flex outwardly in the direction of tubular wall 30 from the first position 702 of retention members 60 to the second position 704 of retention members 60 by the passage of fish 2 in aperture 26. Each retention member 60 returns to the first position 702 and functions to retain fish 2 in retrieving device 10, once the displacing force of the fish 2 is lessened or removed, illustratively, by the passing of the widest girth of fish 2 past at least a portion of retention member 60. This precludes fish 2 in the predetermined range of sizes of retrieving device 10 from exiting back through distal end portion 22 of the tube 30 and aperture 46 of the funnel 40.

Referring now to FIG. 4, with fish retention member 60 in the first position, a hook of fishing line 4 can be safely removed from fish 2 by holding onto handle 70 and/or tube 20 with one hand, and then manipulating the hook 3 free from the fish 2 with the second hand. Retrieving device 10 provides a safe and easy way to retain fish 2 for a period of time without the risk of fish 2 engaging its spines into the angler or wriggling free. While fish 2 is retained in retrieving device 10, the longitudinally aligned scale 38 and circumferential scale 39 (see FIG. 1) can be used for measuring the length and the girth of fish 2, respectively. Proximal end 24 can include an adjustable strip (not shown) to block the proximal passage of fish 2 and/or position the head of fish 2 for measurement.

Referring now to FIG. 5, device 10 can be manually flexed using one or more hands on tube 20 to decrease the cross-sectional area and closely align tubular wall 30 around the maximum girth of fish 2 for measurement. In addition, fish 2 can be weighed by suspending the retrieving device 10 and fish retained therein from a portable weight scale using a receptacle or through hole 76 positioned, for example, in handle 70, and subsequently subtracting the weight of device 10. This enables the angler to rapidly measure the length, girth and weight of the secured fish in order to determine whether it can be legally kept and/or for record keeping/tagging purposes.

As shown in FIGS. 4 and 6, once the desired measurement and/or tagging tasks have been performed and/or the hook 3 and line 4 is removed, fish 2 can be released from retrieving device 10. In particular, the proximal end portion 24 of tube 20 is turned downward, and fish 2 can be observed emerging from proximal end portion 24 of tube 20. Alternatively, fish 2 can be securely held in position in retrieving device 10 by the manually gripping tube 20 and fish 2.

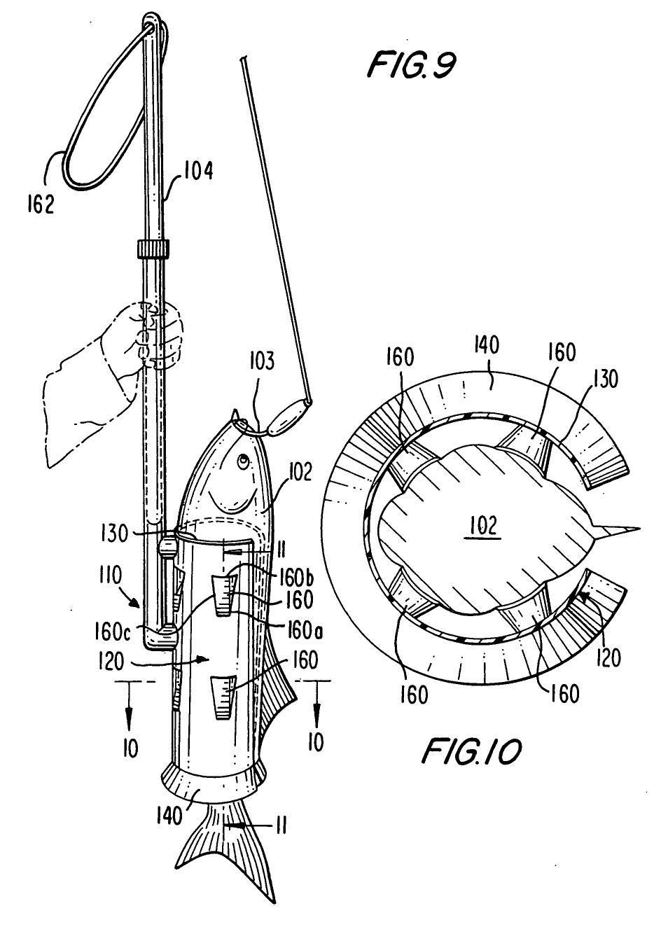

Referring now to FIG. 9 there is shown an alternative embodiment 110 of the present invention, including plastic tube 120 having fish retention members 160 formed as part of the tube 120. This embodiment contrasts with the previous embodiment in that funnel 140 has been replaced by a flared end 140 of tube 120, and fish retention members 60 of the previous embodiment have been replaced by fish retention members 160 which are preferably formed by three (3) appropriately positioned and dimensioned cuts 160a, 160b and 160c in the tube wall 130. Thus, after effecting the cuts 160 a-c, the retention members 160 may assume a natural bias inwardly of the tube wall 130. Alternatively, the retention members 160 may be subjected to heat while applying inward pressure to cause them to lean inwardly of the tube as shown.

The flared end 140 of tube 120 can be formed by application of heat followed by positioning of the end of the tube 120 over an approximately shaped forming tool. Alternatively, the entire tube 130, including the flared end 140 and the fish retention members 160 may be integrally and monolithically molded as a single piece.

As noted previously, the tube 120 can be formed of various types of moldable plastics, injection molded or otherwise, such as polyvinyl chloride (PVC), nylon, polyethylene or the like. Alternatively, the tube 120 can be made of other materials such as wood, metal or the like without departing from the scope of the invention. With other materials, the retention members 160 and the flared end would have to be made according to methods known to those skilled in the art.

The embodiment shown in FIG. 9 is particularly preferred since it includes two circular aligned end “parallel” rows of fish retention members 160 as shown to insure sufficient attachment of fish of various sizes. While each row contains four (4) such members 160, alternatively each row can be formed with a lesser or a greater number of such members.

Hanging strap 162 can also be wrapped around the user's arm while fishing to provide additional grip on the device and to prevent loss in the event a large and active fish is caught.

FIG. 10 is a cross-sectional view taken along lines 10-10 of FIG. 9 and illustrating the attachment of retention members 160 to the example fish 102.

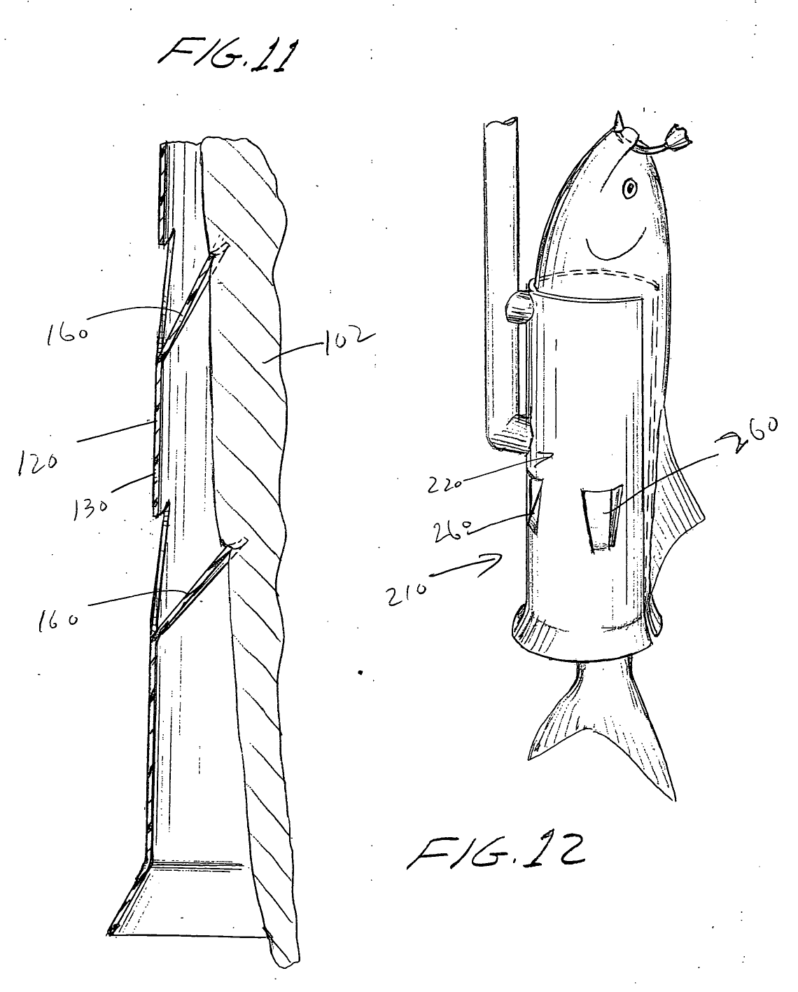

FIG. 11 is a cross-sectional view taken along line 11-11 of FIG. 9 and illustrating the respective locations of attachment of the retention members 160 and the fish 102.

Referring now to FIG. 12, there is illustrated a left side elevational view of still another alternative embodiment 210 of the invention including tube 220 having a single row of four retention members 260 positioned in equidistant relation about the circumference of the tube 220 as shown. This embodiment is contemplated for use with particularly sized fish, such as those of the larger variety, since retention members 160 will always be capable of attachment to the catch.

Alternative embodiments of the invention can be envisioned by those skilled in the art without departing from the true scope of the invention.

The device can be made of any polymeric plastic material, such as PVC, polyethylene, or the like. Alternatively any other suitable material can be used, such as bendable metal, ceramics, etc.

It will be apparent to those skilled in the art that various modifications can be made to the present invention without departing from the spirit and scope of the invention. It is therefore intended that the present invention encompass all such modifications and variations so long as they fall within the scope of the appended claims and their equivalents.

What is claimed is:

1. An apparatus for retrieving a fish attached to a line, which comprises:
a tube having a flexible wall extending between a distal end portion and a proximal end portion, said tube wall defining a tube aperture aligned with a central longitudinal axis and including a first longitudinal edge and a second opposed longitudinal edge, at least one of the longitudinal edges being flexibly movable relative to the opposed longitudinal edge;
a funnel having a flexible wall extending between a distal end portion and a proximal end portion of the funnel and defining a funnel aperture therebetween, the funnel being connected to the distal end portion of the tube, wherein the funnel aperture is aligned with the tube aperture along the central longitudinal axis; and
at least one fish retention member positioned adjacent the tube aperture to accommodate unidirectional passage of the fish through the tube, while preventing exiting out of the tube in the opposite direction.

2. The apparatus of claim 1, wherein at least one of the longitudinal edges of the tube is flexibly movable to change a cross-sectional area normal to the longitudinal axis of the tube.

3. The apparatus of claim 2, wherein the first longitudinal edge and the second longitudinal edge of the tube wall at least partially overlap.

4. The retrieving device of claim 3, wherein the first longitudinal edge and the second opposed longitudinal edge of the tube defines a tube passageway.

5. The apparatus of claim 4, wherein the tube passageway is in fluid communication with the tube aperture.

6. The apparatus of claim 5, wherein at least one of the longitudinal end portions of the tube is in direct contact with the opposed tubular wall, and the tube passageway is selectively definable by flexing of the tube wall.

7. The apparatus of claim 1, wherein the longitudinal edges of the tube wall are flexibly positioned in spaced relation and at least partially define a tubular passageway.

8. The apparatus of claim 1, wherein the proximal end portion of the funnel is connected to the distal end portion of the tube.

9. The apparatus of claim 1, wherein said funnel wall further comprises a first longitudinal edge and a second opposed longitudinal edge, wherein at least one of the funnel longitudinal edges is flexibly movable relative to the opposed longitudinal edge.

10. The apparatus of claim 9, wherein the first longitudinal edge and the second opposed longitudinal edge of the funnel defines a funnel passageway, wherein the funnel passageway communicates with the tube passageway.

11. The apparatus of claim 1, wherein the tube wall and the funnel wall are flexibly movable between a first position having a first cross-sectional area normal to the longitudinal axis and a second position having a second cross-sectional area normal to the longitudinal axis.

12. The apparatus of claim 1, wherein the at least one retention member is formed on an inner surface of said tube wall proximate said distal end portion of the tube.

13. The apparatus of claim 1, wherein the at least one retention member flexibly pivots between a first position and second position.

14. The apparatus of claim 13, wherein said first position is normally biased towards said central longitudinal axis, and said second position is displaced proximate the tube wall.

15. The apparatus of claim 1, wherein the at least one retention member comprises a plurality of retention members formed on an inner surface of said tube wall and extend inward towards the central longitudinal axis.

16. The apparatus of claim 15, wherein the plurality of retention members are circumferentially spaced along the inner surface of said tube wall proximate said distal end portion of the tube.

17. The apparatus of claim 1 further comprising a handle connected to the tube.

18. The apparatus of claim 1 further comprising at least one scale formed on the tube wall.

19. The apparatus of claim 1, wherein the funnel further comprises a scoop portion formed at the distal end portion of the funnel.

20. The apparatus of claim 15, wherein the plurality of retention members is attached to the tube by fasteners.

21. The apparatus of claim 15, wherein the plurality of retention members is monolithically formed with the tube.

22. A method for retrieving a fish attached to a line comprising the steps of:
positioning a fish retrieving device adjacent the fish, the fish retrieving device comprising a tube having a flexible wall extending between a distal end portion and a proximal end portion, said tube wall defining a tube aperture aligned with a central longitudinal axis and including a first longitudinal edge and a second opposed longitudinal edge, where at least one of the longitudinal edges is flexibly movable relative to the opposed longitudinal edge, said first longitudinal edge and second opposed longitudinal edge of the tube defining a tube passageway; a funnel having a flexible wall extending between a distal end portion and a proximal end portion and defining a funnel aperture therebetween, the funnel being connected to the distal end portion of the tube, wherein the funnel aperture is aligned with the tube aperture along the central longitudinal axis; and at least one retention member positioned in the tube aperture to accommodate unidirectional passage of the fish through the tube;
positioning the line at least partially through the passageway and the aperture of the tube;
pulling the line to draw the fish attached thereto into the tube aperture;
retaining the fish in the aperture using the at least one retention member; and
retrieving the fish from the tube aperture through the proximal end portion of the tube.

23. The method of claim 22, wherein the step of pulling the line further includes flexing the cross-sectional area normal to the longitudinal axis, as required, for the tube to receive the object.

24. A method for retrieving an object attached to a line comprising the steps of:
positioning an object retrieving device proximate said object, said object retrieving device comprising a tube having a flexible wall extending between a distal end portion and a proximal end portion, said tube wall defining a tube aperture aligned with a central longitudinal axis and including a first longitudinal edge and a second opposed longitudinal edge, where at least one of the longitudinal edges is flexibly movable relative to the opposed longitudinal edge, said first longitudinal edge and second opposed longitudinal edge of the tube defining a tube passageway; a funnel having a flexible wall extending between a distal end portion and a proximal end portion and defining a funnel aperture therebetween, the funnel being connected to the distal end portion of the tube, wherein the funnel aperture is aligned with the tube aperture along the central longitudinal axis; and at least one retention member positioned in the tube aperture to accommodate unidirectional passage of the object through the tube;
positioning the line at least partially through the passageway and the aperture of the tube;
pulling the line to draw the object attached thereto into the tube aperture;
retaining the object in the aperture using the at least one retention member; and
retrieving the object from the tube aperture through the proximal end portion of the tube.

25. An apparatus for retrieving fish attached to a line, which comprises:
a) a generally tubular member defining a tubular aperture for reception of the fish therein, said tubular member including a generally longitudinal opening for entry and passage of the line; and
b) a plurality of fish retention members associated with said tubular member and resiliently biased inwardly sufficient to engage a fish guided into said tubular aperture by the line.

26. The apparatus for retrieving fish according to claim 25, wherein said tubular member has a proximal end portion and a distal end portion, and said distal end portion is generally flared to permit guided reception of the fish into said tubular member.

27. The apparatus for retrieving fish according to claim 26, further comprising an elongated handle attached to said tubular member and extending generally longitudinally thereof for positioning and supporting said tubular member for reception of the fish.

28. The apparatus for retrieving fish according to claim 27, wherein said plurality of fish retention members are formed as part of said tubular member and are biased inwardly thereof.

29. The apparatus for retrieving fish according to claim 28, wherein two rows of said fish retention members are respectfully equally spaced about the periphery of said tubular member and spaced apart from each other, each said row having at least four fish retention members.

30. The apparatus for retrieving fish according to claim 28, wherein one row of said fish retention members is provided about the periphery of said tubular member.

31. A method for retrieving a fish attached to a line, utilizing a generally tubular member defining a tubular aperture for reception of the fish therein, the wall of said tubular member including a generally longitudinally extending opening for entry and passage of the line, and at least one fish retention member associated with said tubular member, said at least one fish retention member extending inwardly thereof sufficient to engage a fish guided into said tubular aperture by the line, comprising:
a) positioning said tubular member adjacent the fish; and
b) guiding the fish adjacent the tubular aperture of said generally tubular member utilizing the line, and guiding the fish into said generally tubular member until said at least one fish retention member engages the fish to retain it within said generally tubular member.

32. The method according to claim 31, wherein said generally tubular member includes a plurality of fish retention members.

33. A method for retrieving a fish attached to a line, utilizing a generally tubular member defining a tubular aperture for reception of the fish therein, the wall of said tubular member including a generally longitudinally extending opening for entry and passage of the line, and a plurality of fish retention members associated with said tubular member, said fish retention members extending inwardly thereof sufficient to engage a fish guided into said tubular aperture by the line, comprising:
a) positioning said tubular member adjacent the fish; and
b) guiding the fish adjacent the tubular aperture of said generally tubular member utilizing said line, and guiding the fish into said generally tubular member until said fish retention members engage the fish to retain it within said generally tubular member.

34. An apparatus for retrieving fish attached to a line, which comprises:
a) a generally tubular member defining a tubular aperture for reception of the fish therein, the wall of said tubular member including a generally longitudinally extending opening for passage of the line; and
b) at least one fish retention member associated with said tubular member and extending inwardly sufficient to engage a fish guided into said tubular aperture by the line.

35. The apparatus according to claim 34, wherein said tubular member includes a plurality of such fish retention members.
